(19) United States
(12) Patent Application Publication
(10) Pub. No.: US 2017/0318869 A1
(43) Pub. Date: Nov. 9, 2017

(54) SYSTEM TO DISSUADE FLYING, STINGING INSECTS

(71) Applicant: APISHIELD, LLC, EDINBURG, TX (US)

(72) Inventors: Joe Studer, McAllen, TX (US); Ludivina Avila, McAllen, TX (US); Mario Campbell, Edinburg, TX (US)

(21) Appl. No.: 15/302,998

(22) PCT Filed: Apr. 8, 2015
(86) PCT No.: PCT/US15/24875

§ 371 Date: Oct. 9, 2016

Related U.S. Application Data
(60) Provisional application No. 61/978,181, filed on Apr. 10, 2014.

(51) Int. Cl. A41D 13/00; A01N 65/00

(52) U.S. Cl. CPC A41D 13/001; A41D 13/0012; A01N 65/00

(57) ABSTRACT

The invention includes a system for dissuading flying, stinging Insects that is economical and easy-to-carry; and methods of making and using said system. The system may comprise: a holding device; a head covering; a dispensing container; and a jumping jack.

### CROSS-REFERENCE TO RELATED APPLICATIONS

This application claims the benefit of U.S. Provisional Appl. No. 61/978,183, filed Apr. 10, 2014, the contents of which are incorporated by reference herein In their entirety.

### FIELD OF THE INVENTION

The field of the invention relates generally to systems to dissuade flying, stinging insects, and methods of making and using said systems.

### BACKGROUND

Flying, stinging insect attacks, including attacks by bees, affect thousands of people every year. Approximately 50-100 people die in the U.S. every year from bee stings.

Flying, stinging insect attacks especially impacts individuals who are working in areas with equipment and/or utilities that are close to, or occupied by, a nest of stinging insects. Social stinging insects especially pose a threat to the victim's life and/or health because of the organized nature of the attack.

The inventors surprisingly discovered a system for dissuading flying, stinging insects that is economical and easy-to-carry. Additionally, the system is portable and easily deployed. Furthermore, unlike traditional systems to dissuade flying, stinging insects, this system does not need additional equipment to transport and/or mount the system.

This background information is provided tor the purpose of making information believed by the applicant to be of possible relevance to the present invention. No admission is necessarily intended, nor should it be construed, that any of the preceding information constitutes prior art against the present invention.

### SUMMARY

The inventors surprisingly discovered a system for dissuading flying, stinging insects. This system can be easily and conveniently carried on the user and deployed by the individual in the field quickly when needed. The system may be used to protect and/or dissuade flying, stinging insects.

The system may be stored, or carried, in a pouch, on a belt or vest, or in a compartment in the collar or upper back, and so that the system can be easily deployed in at moment's notice.

The head covering addresses one of the primary targets of stinging insects' attack. In particular, flying, stinging insects typically attack the head and face.

In some embodiments, the system, comprises:
1) a holding device;
2) a head covering;
3) a dispensing container; and
4) a jumping jack.

In further embodiments, the system comprises:
1) a head covering;
2) a dispensing container; and
3) a jumping jack.

The system may include a head covering, wherein the head covering is a hood or sheet. In some embodiments, the head covering comprises a polymeric material (e.g. clear plastic), mesh, and/or netting.

In some embodiments, the system comprises a dispensing container, such as a spray container. The dispensing container may be, for example, an aerosol spray container. Furthermore, the dispensing container may be pressurized.

In some embodiments, the dispensing container comprises one or more ingredients that will dissuade the stinging insects from attacking and/or reduces the number of attacking insects. These ingredients include detergents that, inter alia, wet the stinging insects and disable their ability to fly. Other ingredients include natural oil or derivatives thereof. In some embodiments, the ingredient(s) is biodegradable and human safe.

In some embodiments, the dispensing container contains at least a liquid substance.

In some embodiments, the dispensing container contains at least a foam substance.

In further embodiments, the liquid and/or the foam substance comprises one or more ingredients selected from the group consisting of natural oil or derivatives thereof, detergent or derivatives thereof, and combinations thereof.

In some embodiments, the liquid and/or the foam substance is biodegradable.

The dispensing container may comprise one or more dispensing nozzles. Furthermore, the dispensing container may comprise more than one dispensing nozzle.

In some embodiments, the system is attached to a belt or harness. In further embodiments, the system is attached to an animal, or to a vehicle.

In some embodiments, the system is attached to a vest. The vest may include one or more reflective materials.

In some embodiments, the system comprises a holding device. The holding device may be, for example, a pouch, bag, rigid container, or sack, or combinations thereof.

In some embodiments, the system includes a jumping jack. The jumping jack may include at least one attractive color, such as black, orange, etc. In further embodiments, the jumping jack is deployed from a storage compartment (e.g. non-obtrusive compartment) and may move around and create a noise.

In some embodiments, the jumping jack is gas-powered. In some embodiments, the gas is used to create a pneumatic motion, and produce the desired sound. The gas may be treated with a chemical attractant and/or a chemical that stimulates a defensive response from the stinging insects.

In further embodiments, the jumping jack is electric and/or battery powered.

The invention also includes a method of preparing said system to dissuade one or more flying, stinging, insects. In some embodiments, the method comprises assembling two of more components selected from the group consisting of a holding device, a head covering, a dispensing container, and a jumping jack.

In further embodiments, the method comprises assembling components selected from the group consisting of a holding device, a head covering, a dispensing container, and a jumping jack.

Furthermore, the method comprises assembling components selected from the group consisting of a head covering, a dispensing container, and a jumping jack.

It is to be understood that both the foregoing general description of the invention and the following detailed description are exemplary, and thus do not restrict the scope of the invention.

### BRIEF DESCRIPTION OF THE FIGURES

FIG. 1. Close up view and demonstration of use of an exemplary embodiment of dispensing container component.

FIG. 2A. Demonstration of an exemplary embodiment where the invention is attached via belt based system.

FIG. 2B. Demonstration of an exemplary embodiment where the invention is attached via safety vest based system.

FIG. 3. “Jumping Jack” in an exemplary storage configuration.

FIG. 4. “Jumping Jack” in an exemplary deployed configuration.

FIG. 5. Detailed view of oscillating pneumatic system in “Jumping Jack”

FIG. 6. Detailed view of hinge and spring system in “Jumping Jack”

FIG. 7. Detailed view of both linear and rotational “Jumping jack”valve assemblies.

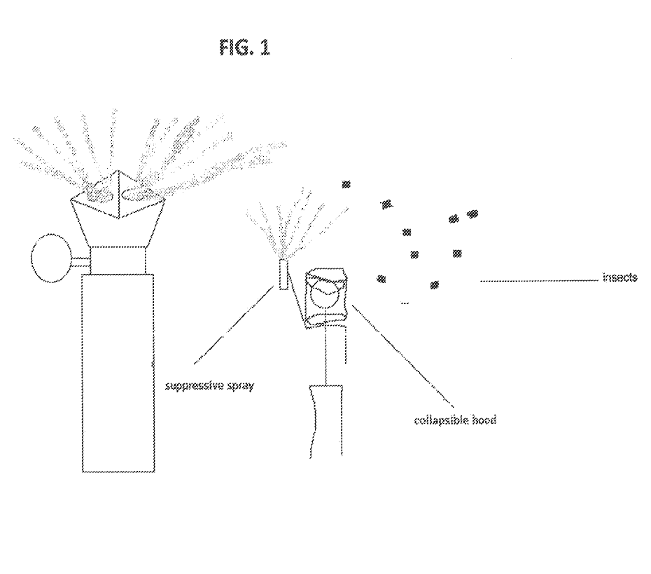

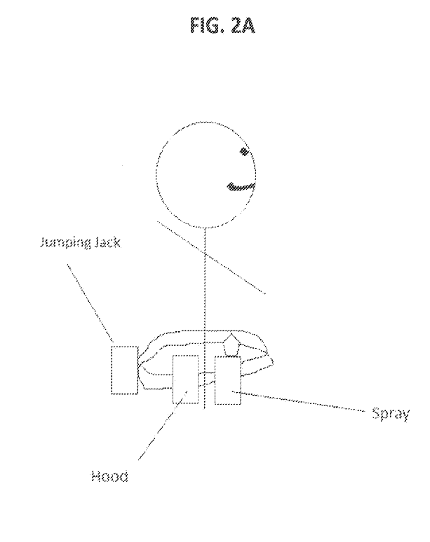

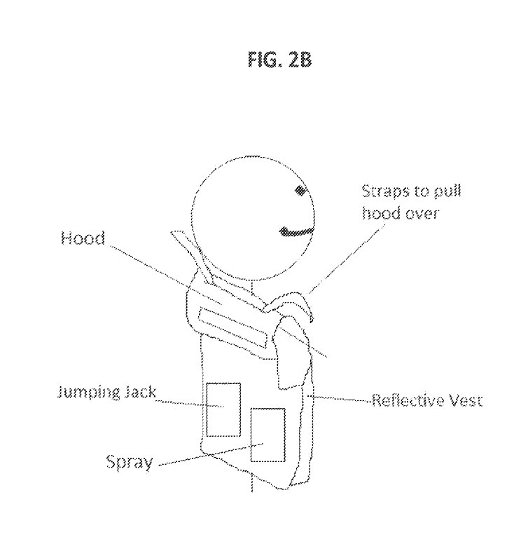

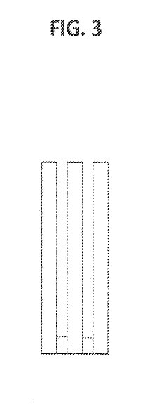

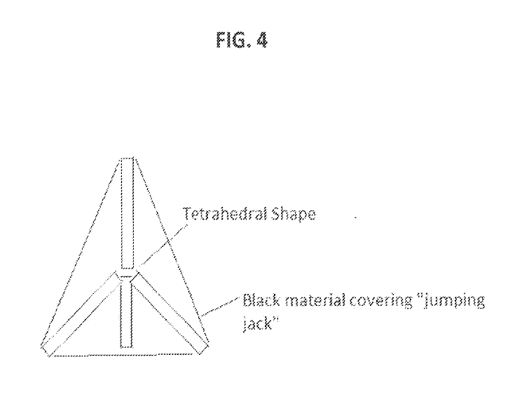

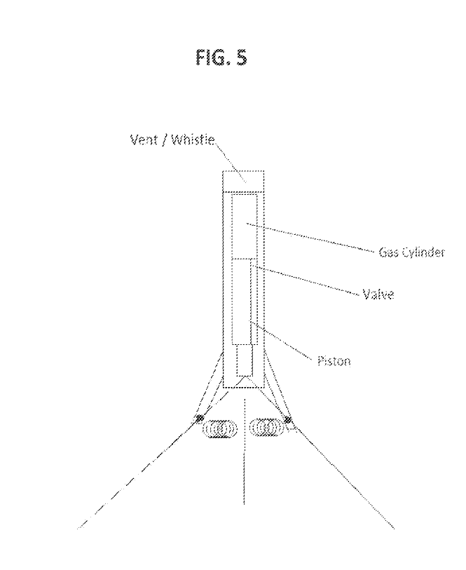

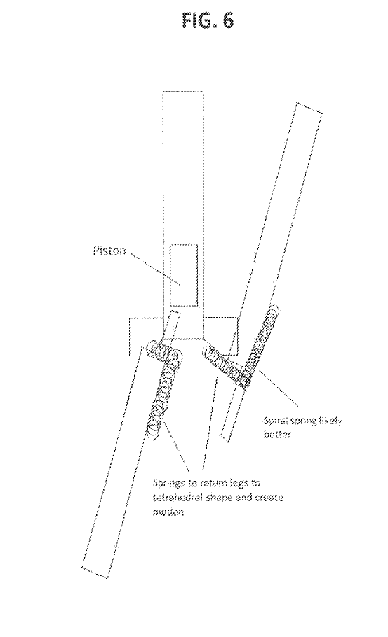

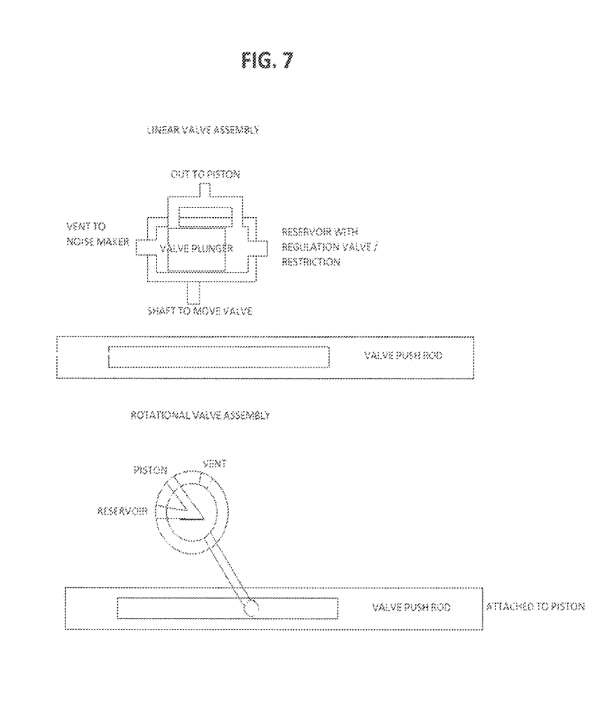

FIGS. 1-7 demonstrates various embodiments of the invention and is not meant to be limiting.

### DETAILED DESCRIPTION

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated embodiments of the invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term, “comprising,” those skilled in the art would understand that, in some specific instances, the embodiment or embodiments can be alternatively described using the language “consisting essentially of” and/or “consisting of.”

### Definitions

The term “dispensing container” as used herein includes a pressurized or unpressurized container to dispense a liquid-substance, foam substance, or a combination thereof. The dispensing container may dispense its contents by spray, shower, sprinkle, jet, mist, drizzle, etc.

“Head covering” as used herein includes a device to completely cover the head and upper shoulders of the user so as to prevent the entrance of a stinging insect into the head, neck and shoulder portion of the user. This device may comprise a structure such as a brim, etc., which inter alia, holds the material of the head covering away from the race of the user.

“Jumping jack” as used herein includes a device comprised of a motion device and an outer covering. The motion device creates motion intended to be attractive to defensive stinging insects. The motion device may be powered by compressed gas or electrical power. The motion device may also release an attractive agent to attract, the defensive stinging insects. The outer covering is comprised of a material which will visually attract the attacking stinging insect and hold the stinger of stinging insects to diminish or disable the insect's ability to further attack the user.

“Holding device” as used herein includes an apparatus to carry, hold, and/or store at least the components of the invention. The holding device may also hold mechanisms, which will assist in the deployment of the components of the invention. The holding device may also have compartments to contain other items such as first aid devices, inter alia, epinephrine dispensing pens.

“Motion device” as used herein includes mechanism, which creates motion through rotation or “jumping” motions allowing the jumping jack to have motion while in the various geometric configurations.

“Vehicle” as used herein includes conveyances powered by electric, gas, battery, manual (e.g. a bicycle), or a combination thereof. The term “vehicle” includes, for example, car, truck, ATV, tractor, pickup track, bicycle, farm vehicle, etc.

A “subject” is a mammal, preferably a human, but can also be an animal, e.g., companion animals (e.g., dogs, cats, and the like), farm animals (e.g., cows, sheep, pigs, horses, and the like), etc.

The holding device may be, attached to, and/or incorporated into, an article of clothing, or the like. For example, the holding device may be worn as a belt or be integrated into outer clothing such as shirt, jacket, pants, vest, blouse, hat, dress, and the like.

In some embodiments, an article of clothing may be modified to carry and/or allow deployment of the invention.

In some embodiments, the holding device may be worn as a part of, and/or attached to a belt, or is integrated into a vest.

In further embodiments, the holding device may be integrated into a fall prevention harness.

In some embodiments, the holding device is incorporated into a bag. For example, the holding device may be attached to the user as a backpack, a pouch worn around the waist, a sling across the individual's chest, neck, etc.

The holding device may include a storage location for other items, such as a device (e.g., a plastic card) for scratching out the stingers once the user has reached safety, and other items that a user may choose to carry, for example, water bottle, juice, bank cards, wallet other personal items, etc. Furthermore, the holding device may also include a storage location for a medical device, such as an “epi pen” (a/k/a an epinephrine administration device).

The dispensing container may comprise a container containing one or more suppressive agents, a tubing to carry the suppressive agent, and a nozzle comprised of one or more nozzles to deliver the suppressive agent(s). In some embodiments, the tubing carries a compressed suppressive agent.

In some embodiments, the dispensing container is pressurized.

Furthermore, in some embodiments, the suppressive agent is a liquid.

In some embodiments, the dispensing container includes a spray portion. The spray portion of the dispensing container may include an aerosol can. Furthermore, the aerosol canister may be modified so that when the system is deployed the aerosol canister may be held in the hand.

In some embodiments, the dispensing container may include a pull pin control mechanism. This pull pin control mechanism, inter alia, allows the user to hold the dispensing container without concern about actuating the container's nozzle. Additionally, the dispensing container may be attached to a holding device, e.g., so that the removal of the dispensing container from its storage location would activate the flow of the suppressive liquid.

Furthermore, the dispensing container may be integrated into the holding device so that, e.g., the flow could be activated by a mechanism built into the holding device, or by a mechanism attached to the holding device so the flow will be activated when the hood is deployed or the jumping jack is deployed. The integrated dispensing container may include a hands free operation/configuration so that, e.g., the spray nozzles are on the shoulders, and/or head of the user of the deployed system. This would, inter alia, allow the user to protect their hands by putting them into their pockets and/or other protective structures.

The dispensing container may comprise multiple dispensing nozzles to, inter alia, rapidly deploy a liquid or foam, which suppresses and/or incapacitates one or more flying insects.

In some embodiments, the dispensing container is in a hand-held configuration. In further embodiments, the dispensing container is incorporated into a reflective safety vest, or fail protection harness.

The head covering may be deployed from a storage compartment and fitted onto the head of the user, for example, by the user manually positioning the head covering. The deployment of the head covering may involve, for example, deployment from a storage compartment on the upper back of the user, to, inter alia, allow the deployment from the back by pulling straps built into the support structure traversing to the front of the carrying device. This would, inter alia, facilitate the deployment of the head covering to prevent stings.

In further embodiments, the head covering is stored (e.g. compactly) and deployed from the holding device.

In some aspects, the head covering comprises a structure utilizing spring steel pieces, which, inter alia, support the netting away from the users face. In some embodiments, the system utilizes spring steel bands to “pop” into shape when desired.

In some embodiments, the head covering is a sheet of mesh material, which is deployed over the user's existing hat or the like. In further embodiments, the head covering comprises a stinger resistant material. The material may be in direct contact with the head and skin. Furthermore, the material may be a single sheet which is stinger resistant (or not). The single sheet would need to be stinger resistant and may actually be composed of various materials to allow protection and transparency for sight.

In further embodiments, the head covering may be a barrier cloth including a mesh component. The head covering may also be a barrier cloth including a substantially non-permeable membrane component.

In some embodiments, the head covering includes a visor component or portion. The visor portion may be formed from a substantially transparent material. Furthermore, the substantially transparent material may comprise polymer, glass or a crystalline matrix.

In further embodiments, the visor portion may be tinted to limit light transmission.

In some embodiments, the invention comprises a jumping jack. The jumping jack may include one or more of the following characteristics, and combinations thereof: attractive color, moves rapidly, makes noise, and releases a chemical and/or biological component, such as an odorant, that attracts attacking stinging insects.

The jumping jack may be deployed by removal from the storage compartment by the user. Furthermore, the jumping jack may be configured so the deployment of the head covering or dispensing container (or holding device) will automatically deploy the jumping jack.

In some embodiments, the jumping jack comprises a motion device with three of the four legs, or two of the four legs, of the motion device capable of moving so that the motion moves by actuation by electrical or compressed gas power. The motion device may be powered by compressed gas (e.g., from a high-pressure storage vessel) or be powered by electrical power (e.g., delivered from a battery). The compressed gas powered device may, inter alia, allow the use of an odorant in the gas, which attracts the stinging insects as the gas is released and the jumping jack moves. In some embodiments, the jumping jack includes a noise-making device actuated by either electrical and/or compressed gas power and may be comprised of a compressed gas operated whistle, or mechanical noisemaker.

The motion device may include a fabric or material covering in a color, which attracts the attacking stinging insect. In some embodiments, this fabric or material is capable of interacting with the stinger of the stinging insect, and, for example, remove the stinger and/or hold the insect in the location, once the insect stings the material covering the jumping jack.

In one aspect, the jumping jack includes a tetahedral shape. In some embodiments, the jumping jack includes symmetrical three-dimensional shapes other than a tetrahedral. The jumping jack may be adapted to have a cubic shape, trigonal bipyramidal shape, or an octahedral shape. In further embodiments, the jumping jack may be configured to take a spherical shape. In some aspects, a motion device is confined inside the jumping jack, and the deployment of the jumping jack inflates the sphere as the compressed gas powers the motion of the motion device.

While the invention has been described with reference to specific embodiments, it will be appreciated that numerous variations, modifications, and embodiments are possible, and accordingly, all such variations, modifications, and embodiments are to be regarded as being within the spirit and scope of the invention.

1. A system comprising:
a head covering;
a dispensing container; and
a jumping jack.

2. (canceled)

3. The system of claim 1, wherein the head covering is a hood or sheet.

4. The system of claim 1, wherein the head covering comprises mesh and/or netting.

5. The system of claim 1, wherein said dispensing container is a spray container.

6. The system of claim 1, wherein said dispensing container is an aerosol spray container.

7. The system of claim 1, wherein said dispensing container is pressurized.

8. The system of claim 1, wherein a dispensing container contains at least a liquid substance.

9. The system of claim 1, wherein a dispensing container contains at least a foam substance.

10. The system of claim 8, wherein said liquid and/or foam substance comprises one or more ingredients selected from the group consisting of natural oil or derivatives thereof, detergent or derivatives thereof, and combinations thereof.

11. The system of claim 8, wherein said liquid and/or foam substance is biodegradable.

12. The system of claim 1, wherein said dispensing container comprises one or more dispensing nozzles.

13. The system of claim 1, wherein said dispensing container comprises more than one dispensing nozzles.

14. The system of claim 1, wherein said system is attached to a belt.

15. The system of any of claim 1, wherein said system is attached to a vest.

16. (canceled)

17. The system of claim 1, wherein said dispensing container is a pouch, bag, rigid container, or sack.

18. A method comprising using the system of claim 1 for dissuading one or more insects.

19. The system of claim 1, wherein said system is attached to a harness.

20. The system of claim 1, wherein said system is attached to an animal.

21. The system of claim 1, wherein said system is attached to a vehicle.

22. A method comprising assembling two or more the components selected from the group consisting of a holding device, a head covering, a dispensing container; and a jumping jack.

23. (canceled)

24. (canceled)
